(19) United States
(12) Patent Application Publication
(10) Pub. No.: US 2009/0158255 A1
(43) Pub. Date: Jun. 18, 2009

(54) TEST METHOD AND TEST DEVICE FOR UNIT CODE USING UNIT TEST CODE

(75) Inventors: Seokjin Yoon, Daejeon (KR); Gyusang Shin, Daejeon (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon (KR)

(21) Appl. No.: 12/334,484

(22) Filed: Dec. 14, 2008

(30) Foreign Application Priority Data
Dec. 18, 2007 (KR) 10-2007-0133142
Jul. 4, 2008 (KR) 10-2008-0064863

(51) Int. Cl. G06F 9/44

(52) U.S. Cl. 717/124

(57) ABSTRACT

The present invention relates to a test method and device for unit codes in a computer program using unit test codes. A unit code test method according to an embodiment of the invention includes receiving unit test codes to be searched; searching the unit test codes through a search engine; receiving transformation parameters; transforming the searched unit test codes in accordance with the transformation parameters; and executing the transformed unit test codes.

### RELATED APPLICATIONS

The present application claims priority to Korean Patent Application Serial Number 10-2007-0133142, filed on Dec. 18, 2007 and Korean Patent Application Serial Number 10-2008-0064863, filed on Jul. 4, 2008, the entirety of which are hereby incorporated by reference.

### BACKGROUND OF THE INVENTION

1. Field of the Invention

The present invention relates to a technique for efficiently using a unit code test program that is generally developed by a developer in a program development step at the time of developing software.

This work was supported by the IT R&D program of MIC/IITA [2007-S-032-01, Development for Multiple Platform Supported Mobile Application S/W Development Environment Technology].

2. Description of the Related Art

A unit code test program is a test program that is used to confirm whether individual units constituting a system, for example, functions or classes are normal or not, which is different from an integration test performed after system integration.

In general, the unit code test program needs to be directly created by a developer, but separated from implementation codes that constitute the system. Further, since a test program needs to be individually created with respect to each of the classes or functions, this becomes very complex. In recent years, various types of software and devices that use the unit code test program created by the above method to automatically test unit codes and collect the test results have been introduced.

For example, a software framework such as xUnit allows the unit code test program to be easily developed and simply executed. Even though the unit code test program still needs to be directly developed by a developer, this development work is regarded as supplementary work by the developer and does not go well.

Further, a technology such as TestVerb of TestQuest suggests a method in which a test program developer combines Test Verb using a test vocabulary constructed by specialists and creates a test program. However, according to this technology, the test vocabulary still needs to be separately constructed, which is troublesome. Further, this technology corresponds to a technology that is related to a special tester, not a software developer.

### SUMMARY OF THE INVENTION

Accordingly, the invention has been made to solve the above-described problems, and it is an object of the invention to provide a test method and a test device that allow a developer to search previously developed unit test codes to extract unit test codes suitable for the development purpose, to effectively transform the unit test codes according to the development purpose to easily create unit test codes, and to test unit codes in a program.

According to an aspect of the invention, there is provided a unit code test method that tests unit codes in a program using unit test codes. The unit code test method includes receiving unit test codes to be searched; searching the unit test codes through a search engine; receiving transformation parameters; transforming the searched unit test codes in accordance with the transformation parameters; and executing the transformed unit test codes to individually test the unit codes in the program.

The unit test codes may include transformation information that is information on subjects to be transformed, and the unit test codes may be transformed on the basis of the transformation information.

The unit test codes may include search information that is information for a search, and the searching of the unit test codes may use the search information to search the unit test codes.

The unit code test method according to the aspect of the invention may further include, after the transforming of the unit test codes, storing the transformed unit test codes.

According to another aspect of the invention, there is provided a unit code test device that tests unit codes in a program using unit test codes. The unit code test device includes a test code storing unit that stores the unit test codes; a keyword input unit that receives unit test codes to be searched; a search engine unit that searches the received unit test codes from the test code storing unit; a transformation parameter input unit that receives transformation parameters; and a test code transforming unit that transforms the unit test codes searched by the search engine unit in accordance with the transformation parameters.

The unit test codes may include transformation information that is information on subjects to be transformed, and the test code transforming unit may transform the unit test codes on the basis of the transformation information.

The unit test codes may include search information that is information for a search, and the search engine unit may use the search information to search the unit test codes.

The transformed unit test codes may be stored in the test code storing unit.

According to the test device and method according to the aspects of the invention, a user can search previously developed unit test codes to perform a test, and transform test codes that are searched in accordance with the desired purpose to perform a test.

Accordingly, since a test program does not need to be created whenever a test is performed, the test can be easily performed and test codes can be reused. As a result, it is possible to save time needed to create the test program in developing the test program and efficiently perform the test.

### BRIEF DESCRIPTION OF THE DRAWINGS

FIG. 1 is a diagram illustrating a test device according to an embodiment of the invention;

FIG. 2 is a flowchart illustrating a test method according to an embodiment of the invention;

FIG. 3 is a diagram illustrating an example of storing test codes according to an embodiment of the invention;

FIG. 4 is a diagram illustrating a screen that is displayed by a test device according to an embodiment of the invention;

FIG. 5 is a diagram illustrating a process of transforming test codes according to an embodiment of the invention; and

FIG. 6 is a diagram illustrating an example of storing transformed test codes in accordance with the invention.

### DESCRIPTION OF THE PREFERRED EMBODIMENTS

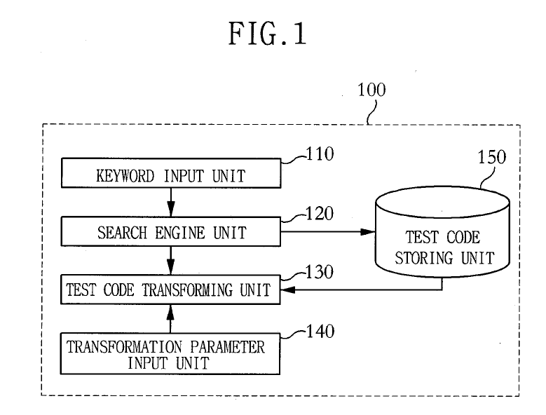

A unit code test device 100 according to an embodiment of the invention will be described with reference to FIG. 1.

The unit code test device 100 includes a keyword input unit 110, a search engine unit 120, a test code transforming unit 130, a transformation parameter input unit 140, and a test code storing unit 150. In this case, the keyword input unit 110 inputs a related keyword that is needed to search a unit test code suitable for the development purpose, and the search engine unit 120 searches a unit test code in accordance with the input keyword. The test code transforming unit 130 transforms the unit test code that is searched by the search engine unit 120, the transformation parameter input unit 140 receives a parameter that is needed to transform the unit test code, and the test code storing unit 150 stores unit test codes that are to be searched.

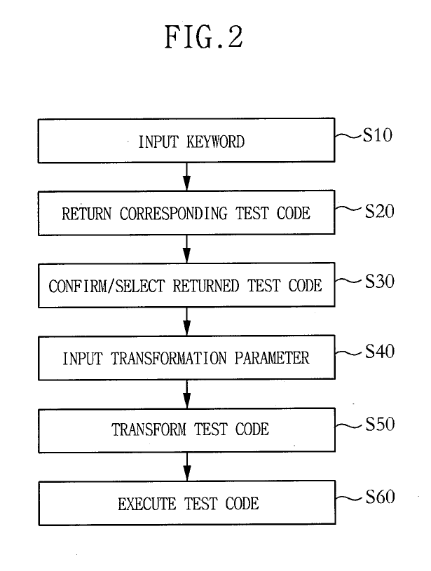

A unit code test method according to an embodiment of the invention will be described in detail with reference to FIG. 2.

First, a developer who performs a unit code test inputs a unit test code to be tested and a related keyword (S10).

The search engine unit 120 uses the input keyword to search the unit test codes stored in the test code storing unit 150 and returns the corresponding unit test code (S20). In order to search a desired unit test code, for example, additional information for a search may be included in each unit test code, which will be described in detail below. The search engine unit 120 searches a matched unit test code through the search process and returns the searched unit test code. At this time, a plurality of unit test codes may be returned in accordance with the searched result.

A user checks the returned unit test code, and confirms whether or not to use the corresponding unit test code or selects a unit test code to be used if a test is performed many times (S30).

Then, in order to transform the unit test code into a unit test code suitable for the purpose, the user inputs a transformation parameter (S40).

The test code transforming unit 130 uses the input transformation parameter to transform the unit test code (S50). Therefore, the unit test code is transformed according to the purpose of the user.

Then, the user confirms and executes the transformed unit test code, and performs a test on the unit code (S60).

Through the above-described process, if the user searches the unit test codes that are stored in the test code storing unit 150 and slightly transforms the searched corresponding unit test code, the user can easily perform a test on the unit code. Since the above process is performed by the unit code test device 100 according to the embodiment of the invention, it is possible to easily and efficiently perform a test on the unit code.

In addition to the above process, the transformed unit test code may be stored again in the test code storing unit 150, and the stored unit test code may be reused, if necessary in the future.

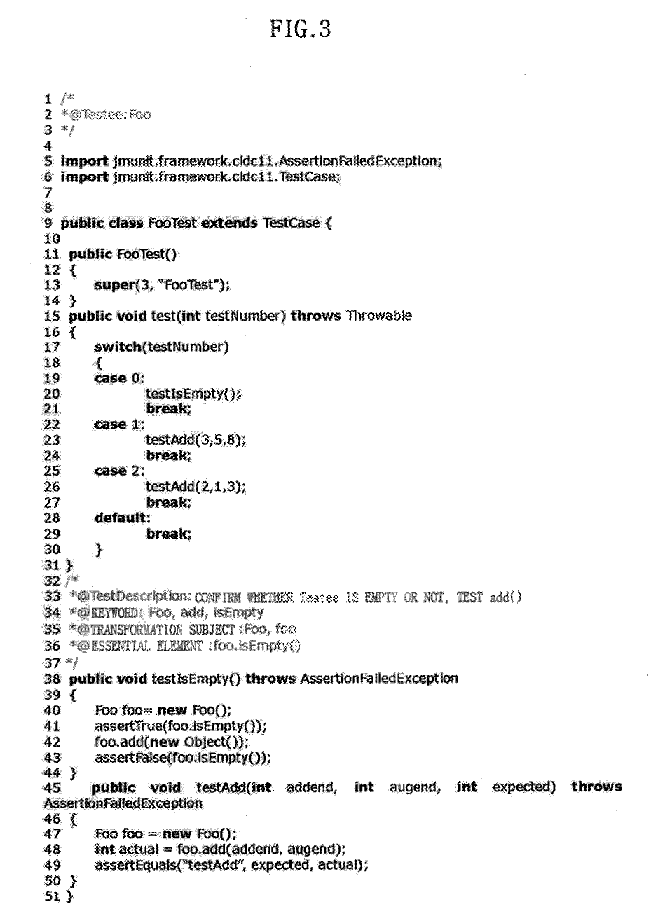

Next, an example of storing unit test codes in the test code storing unit 150 will be described with reference to FIG. 3. The unit test codes that are shown in FIG. 3 are only exemplified and created on the basis of the Java Language.

First, a FooTest( ) class is a test class that is needed to perform a test on a Foo class. In the description below, a class is exemplified as a unit code to perform a unit code test. However, the invention is not limited thereto, and a function or a module may be used as a unit code.

The FooTest( ) class is a constructor of a class, and a class that is used to actually perform a test is a test( ) class. In the exemplified test( ) class, it is confirmed whether a test subject is empty (case 0) and whether an Add ( ) operation of the class is normally performed (case 1 and case 2). That is, if the user executes classes of test(0) and test(1), the user can test whether the tested classes are empty and the add( ) operation is normally performed. The test result may be displayed by using a method in which a value of true or false is returned and the returned value is output to a screen.

In addition, the structure that is shown in FIG. 3 further includes transformation information that is needed to transform the test codes. This transformation information is located between separators that are exemplified as “/*” and “*/”. The transformation information does not affect the execution of the test codes, but may be used to transform the test codes. The transformation information may be easily separated by locating an identifier “@” to a front portion. In FIG. 3, a “@ keyword” is used as a keyword for a search, and a “@ transformation subject” and a “@ essential element” may be used to designate a transformable subject and an essentially required element, respectively. In addition to the transformation information that is shown in FIG. 3, separate information may be input between the separators that are exemplified as “/*” and “*/”, such that the separate information is used for search and transformation without affecting the execution of the unit test codes.

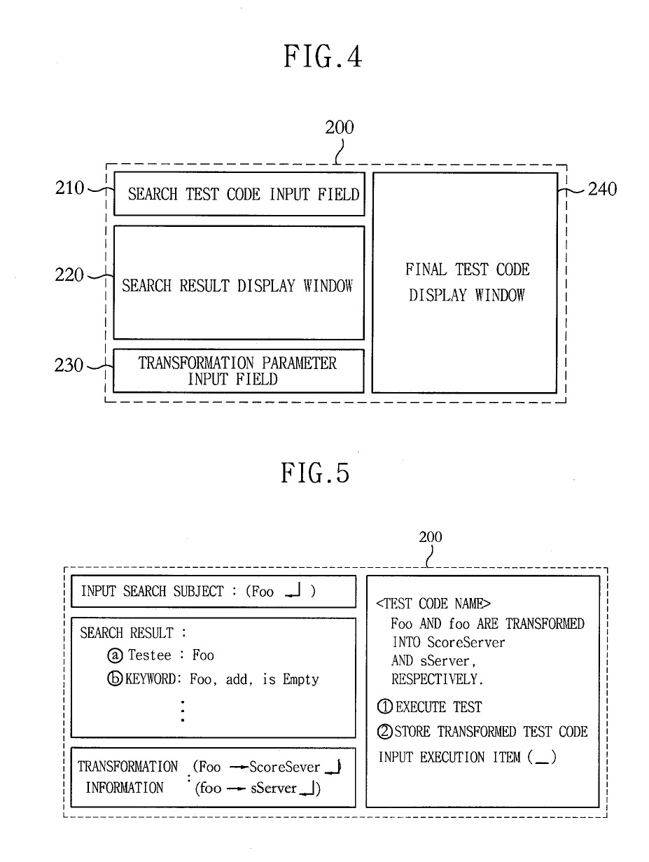

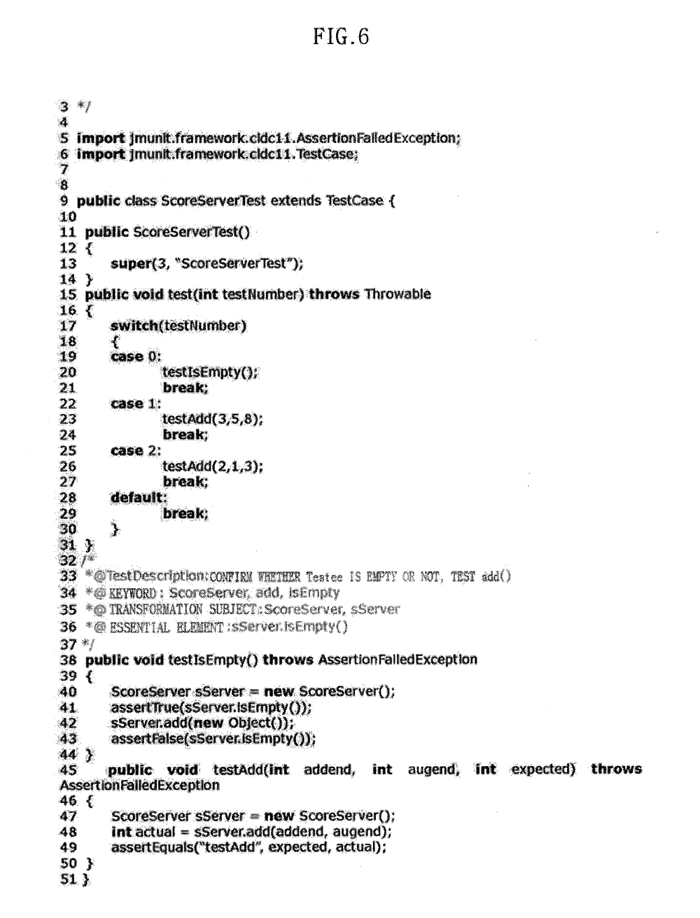

FIG. 4 shows an example of a screen that is displayed on a display device when performing a test method according to an embodiment of the invention.

A display screen 200 includes a search test code input field 210, a search result display window 220, a transformation parameter input field 230, and a final test code display window 240.

First, the search test code input field 210 is a window through which a keyword that is used to search a unit test code is input from a user, and the user inputs the keyword to the search test code input field 210.

When the user inputs the keyword, a result that is searched by the search engine unit 120 is displayed on the search result display window 220. The searched result may be a plurality of unit test codes, and the plurality of unit test codes may be individually displayed on the search result display window 220 or displayed as a list of unit test codes. The user confirms the unit test codes that are displayed on the search result display window 220 and selects a most suitable unit test code from the displayed unit test codes.

When the user selects the desired unit test code, the transformation parameter input field 230 is activated. The transformation parameter input field 230 may be implemented such that a transformation parameter can be input before the above process, but in this embodiment, it is assumed that the user inputs the transformation parameter after confirming the searched result. The user inputs the transformation parameter to transform the selected unit test code. In this embodiment, when the user inputs the transformation parameter, a transformable subject is restricted in consideration of the “@ transformation subject” in the unit test codes. However, the invention is not limited thereto and the transformation subject may be selected using separate transformation information. If necessary, the transformable subject may be displayed on the transformation parameter input field 230.

If the user inputs necessary transformation information to the transformation parameter input field 230, the unit test code that is transformed by applying the transforming parameter is displayed on the final test code display window 240. The user may confirm the unit test code that is displayed on the final test code display window 240, and execute the unit test code or store the transformed unit test code in the test code storing unit 150. When the test code is executed, the execution result may be displayed on the final test code display window 240 or a new screen.

Next, a process of inputting a transformation parameter and transforming the unit test code shown in FIG. 3 will be described with reference to FIG. 5.

When the user inputs “Foo” as a search subject to the search test code input field 210, the unit code test device 100 searches the test codes that are stored in the test code storing unit 150 and displays test code information on a Foo class as the search result on the search result display window 220. In this embodiment, the test codes display items of Foo and foo as the transformation subjects, and the user inputs transformation parameters on the items to the transformation parameter input field 230. When ScoreServer is input with respect to the item of Foo and sServer is input with respect to the item of foo, it is required that the item of Foo is transformed into the item of ScoreServer and the item of foo is transformed into sServer. The final test code display window 240 displays the transformed contents of the test code, and receives information on whether to execute the test code using the transformed test code or to store the transformed test code. The user may use the transformed test code to perform a test on whether the ScoreServer class is empty or an add( ) function of the ScoreServer class is normally performed.

That is, an existing unit test code that tests whether isEmpty( ) and add( ) functions are normally operated with respect to the Foo class is subjected to the transformation process according to the embodiment of the invention, which makes it possible to perform the same test on the ScoreServer class. The user may test a plurality of classes using only a simple transformation process or search another unit test code to perform transformation and test processes. In this embodiment, class names are described as the transformation subjects, but the transformation subjects may correspond to methods and properties in the classes and all regions of other codes.

As described above, the user can perform a test efficiently and quickly by searching and using the previously stored unit test codes and transforming the unit test codes according to the purpose.

In the above-described embodiment of the invention, the unit code test device and method have been described. However, the invention is not limited thereto, and various changes and modifications can be made without departing form the spirit and scope of the invention.

What is claimed is:

1. A unit code test method that tests unit codes in a program using unit test codes, comprising:
receiving unit test codes to be searched;
searching the unit test codes through a search engine;
receiving transformation parameters;
transforming the searched unit test codes in accordance with the transformation parameters; and
executing the transformed unit test codes to individually test the unit codes in the program.

2. The unit code test method of claim 1,
wherein the unit test codes include transformation information that is information on subjects to be transformed, and
the unit test codes are transformed on the basis of the transformation information.

3. The unit code test method of claim 1,
wherein the unit test codes include search information that is information for a search, and
the searching of the unit test codes uses the search information to search the unit test codes.

4. The unit code test method of claim 1, further comprising:
after the transforming of the unit test codes, storing the transformed unit test codes.

5. A unit code test device that tests unit codes in a program using unit test codes, comprising:
a test code storing unit that stores the unit test codes;
a keyword input unit that receives unit test codes to be searched;
a search engine unit that searches the received unit test codes from the test code storing unit;
a transformation parameter input unit that receives transformation parameters; and
a test code transforming unit that transforms the unit test codes searched by the search engine unit in accordance with the transformation parameters.

6. The unit code test device of claim 5,
wherein the unit test codes include transformation information that is information on subjects to be transformed, and
the test code transforming unit transforms the unit test codes on the basis of the transformation information.

7. The unit code test device of claim 5,
wherein the unit test codes include search information that is information for a search, and
the search engine unit uses the search information to search the unit test codes.

8. The unit code test device of claim 5,
wherein the transformed unit test codes are stored in the test code storing unit.
